(19) United States
(12) Patent Application Publication
(10) Pub. No.: US 2004/0019772 A1
(43) Pub. Date: Jan. 29, 2004

(54) Microprocessor

(76) Inventors: Hiroshi Ueki, Tokyo (JP); Masahiro Yokoyama, Tokyo (JP)

Correspondence Address: BURNS, DOANE, SWECKER & MATHIS, L.L.P., P.O. Box 1404, Alexandria, VA, 22313-1404, US

(21) Appl. No.: 10/347,592

(22) Filed: Jan. 22, 2003

(30) Foreign Application Priority Data
Jul. 26, 2002 (JP) 2002-218521

(51) Int. Cl. G06F 9/00

(52) U.S. Cl. 712/235; 712/237

(57) ABSTRACT

A microprocessor includes a register (5) rewritable with software outputs a signal A for determining which one of a successor instruction to be executed when a condition for a conditional branch is satisfied and another successor instruction to be executed when the condition is unsatisfied is to be introduced into a delay slot. When the microprocessor executes a conditional branch, a decode circuit (6) delivers a signal B indicating which one of the successor instruction and the other successor instruction is to be selected as the next instruction to be supplied next to a CPU (1) to a code interface circuit (2).

### BACKGROUND OF THE INVENTION

1. Field of the Invention

The present invention relates to a microprocessor that employs a delay branch method.

2. Description of Related Art

FIG. 12 is a diagram for explaining a pipeline method which a prior art microprocessor employs. The microprocessor executes an instruction that consists of three stages: an instruction fetch (F), an instruction decode (D), and an instruction execution (E) in pipelines, and processes a conditional branch (CBR) immediately after executing a computation instruction (CMP) for rewriting a condition flag, as shown in the figure. In this case, the conditional branch determines whether to jump according to the condition flag that reflects results of the execution of the computation instruction, a transfer instruction or the like. An empty slot of two cycles will be caused because the next instruction to be executed next, which is the destination of the CBR, is fetched after whether a condition for the CBR is satisfied or unsatisfied is determined in the pipeline processing when the CMP has been executed, as shown in the figure. This empty slot is called delay slot.

The method that is called delayed branch has been used in the pipeline method to remove this useless delay slot. The delayed branch is a method of removing a useless empty slot by introducing an instruction placed in an address next to that in which the conditional branch is placed into the delay slot. Improvements in the performance of the microprocessor are expected by using this method.

If it is possible to introduce the next instruction next to the conditional branch CBR into the delay slot when the execution of the CBR results in a failure, and it is also possible to introduce the instruction which is the destination of the CBR when the condition is satisfied into the delay slot, the performance can be improved to a maximum. Therefore, when decoding the CBR by using a built-in a branch prediction circuit, the prior art microprocessor makes predictions on whether or not the branch condition is satisfied. When it is predicted that the branch condition is unsatisfied, the prior art microprocessor introduces the next instruction next to the CBR into the delay slot. In contrast, when it is predicted that the branch condition is satisfied, the prior art microprocessor introduces the instruction which is the destination of the CBR into the delay slot.

A prior art microprocessor constructed as mentioned above has the following problems according to the use of a branch prediction circuit.

In general, a prediction table having a size of about 4K bits is needed to increase a hit ratio of predictions done by the branch prediction circuit up to about 90 to 95%, and therefore the chip area is increased.

Furthermore, primary importance may be attached to the worst performance in the case of incorporating such a prior art microprocessor for equipment control in which real time is essential. In this case, the branch prediction based on a program execution history does not provide adequate processing performance.

### SUMMARY OF THE INVENTION

The present invention is proposed to solve the above-mentioned problems, and it is therefore an object of the present invention to provide a microprocessor that effectively uses a delay slot without using a branch prediction circuit, thereby improving the processing performance thereof.

In accordance with an aspect of the present invention, a microprocessor includes a register rewritable with a program, for outputting a first signal used for determining which one of a successor instruction, which is to be executed when a condition for a conditional branch is satisfied, and another successor instruction, which is to be executed when the condition is unsatisfied, is to be introduced into a delay slot, and a control unit for delivering a second signal that specifies which one of the successor instruction and the other successor instruction is to be supplied to an operation unit according to a value of the first signal to an executable instruction supply unit when the conditional branch is supplied from the executable instruction supply unit to the operation unit.

In accordance with another aspect of the present invention, a microprocessor includes a conditional branch satisfied prediction instruction for introducing a successor instruction, which is to be executed when a condition for a conditional branch is satisfied, into a delay slot and a conditional branch unsatisfied prediction instruction for introducing another successor instruction, which is to be executed when the condition is unsatisfied, into the delay slot, as an instruction set for the conditional branch, and a control unit for setting either one of the conditional branch satisfied prediction instruction and the conditional branch unsatisfied prediction instruction to the conditional branch when a program is created, and for delivering a second signal that specifies which one of the successor instruction and the other successor instruction is to be supplied to an operation unit to an executable instruction supply unit according to the set prediction instruction when the conditional branch is supplied from the executable instruction supply unit to the operation unit.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a microprocessor according to embodiment 1 of the present invention;

FIG. 2 is a diagram showing an example of a program written in an assembler language, in which there is conditional branch (cbr) placed immediately behind a computation instruction (cmp) for rewriting a condition flag;

FIG. 3 is a table showing classified examples of an actual order of instructions to be executed when the program shown in FIG. 2 is executed;

FIG. 4 is a diagram for explaining pipeline processing in a case of a code sequence No. 1 shown in FIG. 3;

FIG. 5 is a diagram for explaining pipeline processing in a case of a code sequence No. 2 shown in FIG. 3;

FIG. 6 is a diagram for explaining pipeline processing in a case of a code sequence No. 3 shown in FIG. 3;

FIG. 7 is a diagram for explaining pipeline processing in a case of a code sequence No. 4 shown in FIG. 3;

FIG. 8 is a table showing classified examples of an actual order of instructions to be executed when a microprocessor according to embodiment 2 of the present invention executes the program shown in FIG. 2;

FIG. 9 is a block diagram showing the structure of a system LSI equipped with a microprocessor according to embodiment 3 of the present invention;

FIG. 10 is a block diagram showing the structure of a microprocessor according to embodiment 4 of the present invention;

FIG. 11 is a table showing classified examples of an actual order of instructions to be executed when a microprocessor according to embodiment 4 of the present invention executes the program shown in FIG. 2; and

FIG. 12 is a diagram for explaining a pipeline method which a prior art microprocessor employs.

### DETAILED DESCRIPTION OF THE PREFERRED EMBODIMENTS

The invention will now be described with reference to the accompanying drawings.

Embodiment 1.

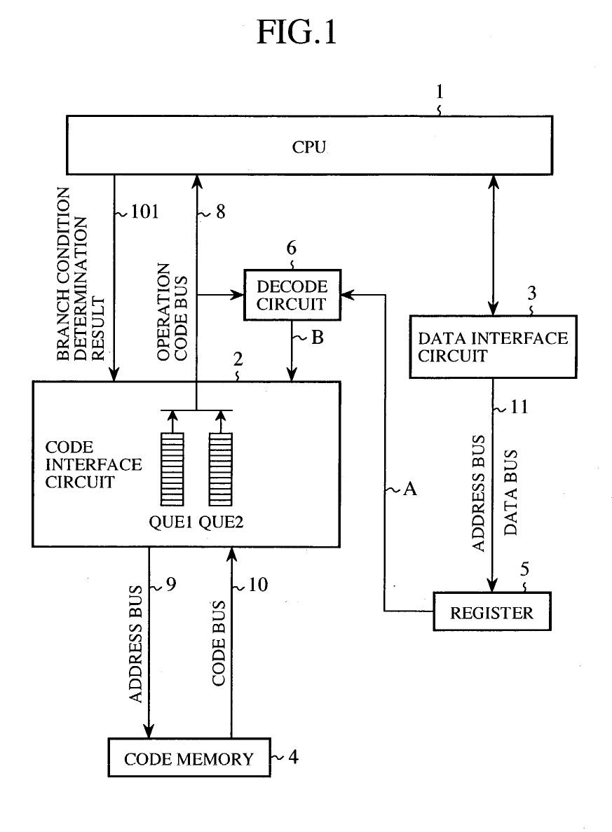

FIG. 1 is a block diagram showing the structure of a microprocessor according to embodiment 1 of the present invention. In the figure, reference numeral 1 denotes a central processing unit (operation unit), which is abbreviated as CPU from here on, reference numeral 2 denotes a code interface circuit (executable instruction supply unit) which is abbreviated as code interface circuit from here on, reference numeral 3 denotes a data interface circuit, reference numeral 4 denotes a code memory, reference numeral 5 denotes a register, reference numeral 6 denotes a decode circuit (control unit), reference numeral 8 denotes an operation code bus, reference numeral 9 denotes an address bus, reference numeral 10 denotes a code bus, and reference numeral 11 denotes an address bus/data bus. The microprocessor according to embodiment 1 of the present invention has a Harvard architecture in which a bus interface unit is divided into the code interface circuit 2 and the data interface circuit 3. As an alternative, the microprocessor can have another architecture.

The code interface circuit 2 delivers an operation code to the CPU 1 by way of the operation code bus 8. The code interface circuit 2 is connected with the code memory 4 by way of the address bus 9 and the code bus 10. The register 5 is rewritable with software, and delivers a signal A (first signal) to the decode circuit 6. The CPU 1 can write and read a value in and from the register 5 by way of the data interface circuit 3.

Next, a description will be made as to the operation of the microprocessor of embodiment 1. When the value of the signal A output from the register 5 is “1”, if the microprocessor executes a conditional branch, an instruction introduced into a delay slot is one that is the destination of the conditional branch when a branch condition for the conditional branch is satisfied. In contrast, if the microprocessor executes a conditional branch when the value of the signal A is “0”, an instruction introduced into the delay slot is one to be executed next when the branch condition is unsatisfied.

Next, how the signal A works will be explained concretely. The operation code delivered to the CPU 1 from the code interface circuit 2, as well as the signal A, are input to the decode circuit 6 by way of the operation code bus 8. If the signal A has a value of “1” and the conditional branch is being put on the operation code bus 8, the decode circuit 6 outputs “1” to the code interface circuit 2 as a signal B (second signal). In other cases, the decode circuit 6 outputs “0” as the signal B to the code interface circuit 2.

In response to the signal B, the code interface circuit 2 outputs the instruction which is the destination of the conditional branch when the branch condition is satisfied to the operation code bus 8 in the next cycle in when the conditional branch will be put on the operation code bus 8 only when the value of the signal B is “1”. The code interface circuit 2 delivers the next instruction to be executed next when the branch condition is unsatisfied to the operation code bus 8 in the next cycle in which the conditional branch will be put on the operation code bus 8 when the value of the signal B is “0”.

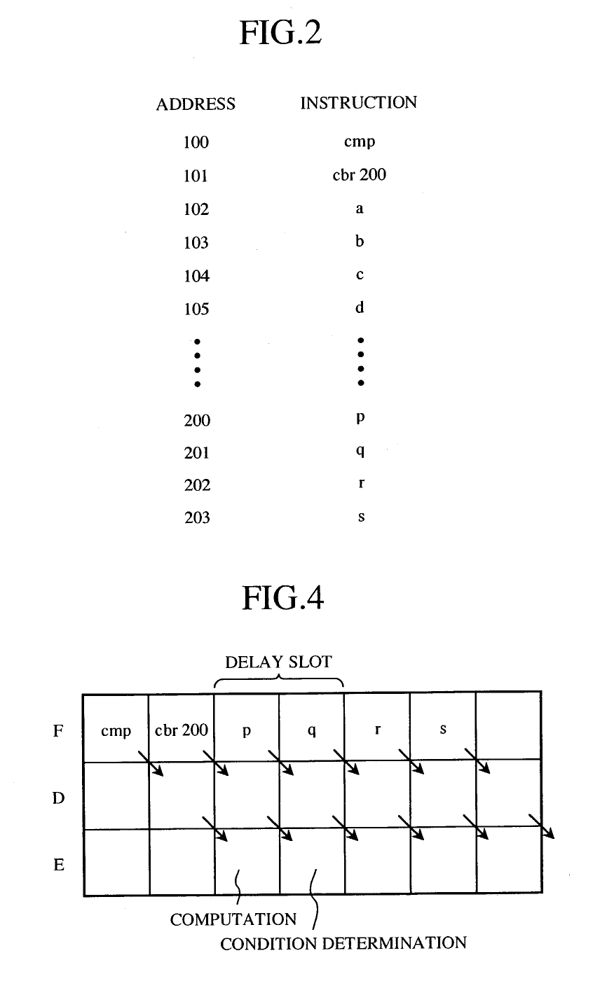

FIG. 2 shows an example of a program written in an assembler language in which there is a conditional branch (abbreviated as cbr from here on) placed immediately behind a computation instruction (abbreviated as cmp from here on) for rewriting a condition flag. The cmp is written at an address 100, and the cbr 200 is written at an address 101. The cbr 200 is a conditional branch for jumping the program to an address 200 when the condition for the cbr 200 is satisfied. An instruction a is written at an address 102, an instruction b is written at an address 103, an instruction c is written at an address 104, an instruction d is written at an address 105, an instruction p is written at an address 200, an instruction q is written at an address 201, an instruction r is written at an address 202, and an instruction s is written at an address 203.

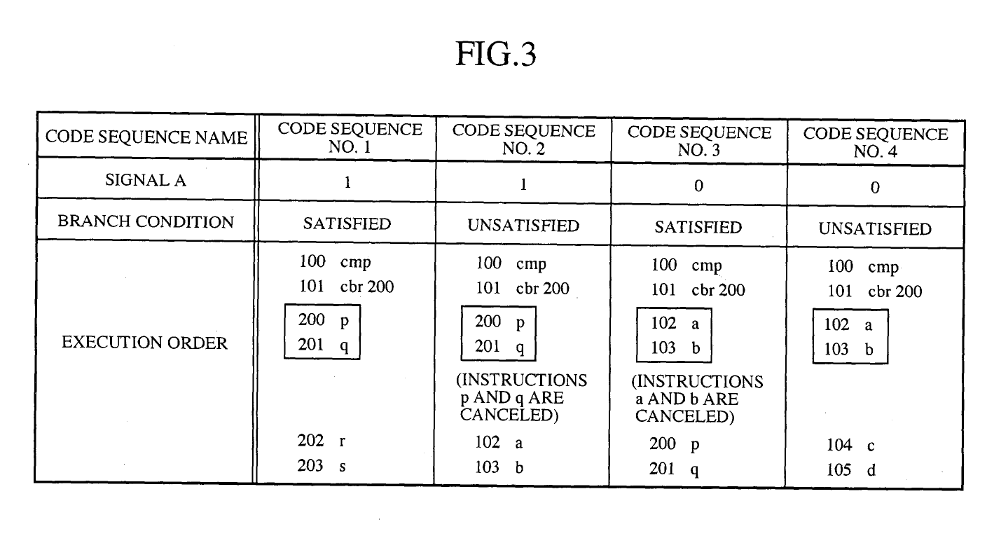

FIG. 3 is a table showing classified examples of the actual order of instructions to be executed when the program shown in FIG. 2 is executed. Four code sequences No. 1 to No. 4 can be provided according to the value of the signal A and whether the branch condition for the cbr 200 is satisfied or unsatisfied. In the figure, instructions enclosed by a square in each code sequence are ones to be introduced into the delay slot.

Next, a description will be made as to the operation of the microprocessor for each code sequence. FIG. 4 is a diagram for explaining the pipeline processing in the case of the code sequence No. 1. When the code interface circuit 2 delivers the cmp to the operation code bus 8, the CPU 1 enters the cmp into the F stage. When the code interface circuit 2 supplies the cbr 200 to the operation code bus 8 in the next cycle, the cbr 200 is entered into the F stage. At this time, because the signal A has a value of “1” and the conditional branch is placed on the operation code bus, the decode circuit 6 sets the value of the signal B to “1”. In response to the signal B having a value set to “1”, the code interface circuit 2 delivers the instruction p, which is the destination of the conditional branch with the condition satisfied, to the operation code bus 8 in the next cycle. The code interface circuit 2 further delivers the instruction q to the operation code bus 8 in the next cycle. As a result, the two instructions p and q are introduced into the delay slot. Then, when the CPU 1 determines, in the E stage of the cbr 200, that the branch condition is satisfied, results 101 caused by the branch condition determination are delivered to the code interface circuit 2. In response to the branch condition determination results 101, the code interface circuit 2 delivers the two instructions r and s to the operation code bus 8 in the next or later cycle.

Thus, when the cbr 200 is executed with the value of the signal A being preset to “1” with the program, the instruction p, which is the destination of the conditional branch with the condition satisfied, and the next instruction q are sequentially entered into the delay slot. After that, it is determined, in the stage E of the cbr 200, that the condition is satisfied, and the instructions r and s are sequentially executed. When the branch condition is thus satisfied with the signal A having a value of “1”, the delay slot are filled with the instructions p and q which are the destination of the conditional branch and this results in an improvement in the CPU performance.

FIG. 5 is a diagram for explaining the pipeline processing in the case of the code sequence No. 2. When the code interface circuit 2 supplies the cbr 200 to the operation code bus 8, the value of the signal B becomes “1” because the signal A has a value of is “1” even in the case of the code sequence No. 2. The code interface circuit 2 therefore outputs the instruction q in a cycle next to the cycle in which the cbr 200 is delivered to the operation code bus 8, and then outputs the next instruction q. As a result, the two instructions p and q are introduced into the delay slot. Then, when the CPU 1 determines, in the E stage of the cbr 200, that the branch condition is unsatisfied, results 101 caused by the branch condition determination are delivered to the code interface circuit 2. In response to the branch condition determination results 101, the code interface circuit 2 delivers the instructions a and b to the operation code bus 8 in the next or later cycle. The CPU 1 then cancels the execution of the instructions p and q that need not be executed because the branch condition is unsatisfied.

When the value of the signal A is thus set to “1”, the instructions p and q entered into the delay slot are canceled if determined that the condition for the cbr 200 is unsatisfied. Furthermore, after whether the condition for the cbr 200 is satisfied or unsatisfied is determined, the instruction a which is to be exectued next and the next instruction b are delivered to the CPU 1. When the branch condition is thus unsatisfied with the signal A having a value of “1”, the delay slot are not filled with any effective instructions and this results in no improvement in the CPU performance.

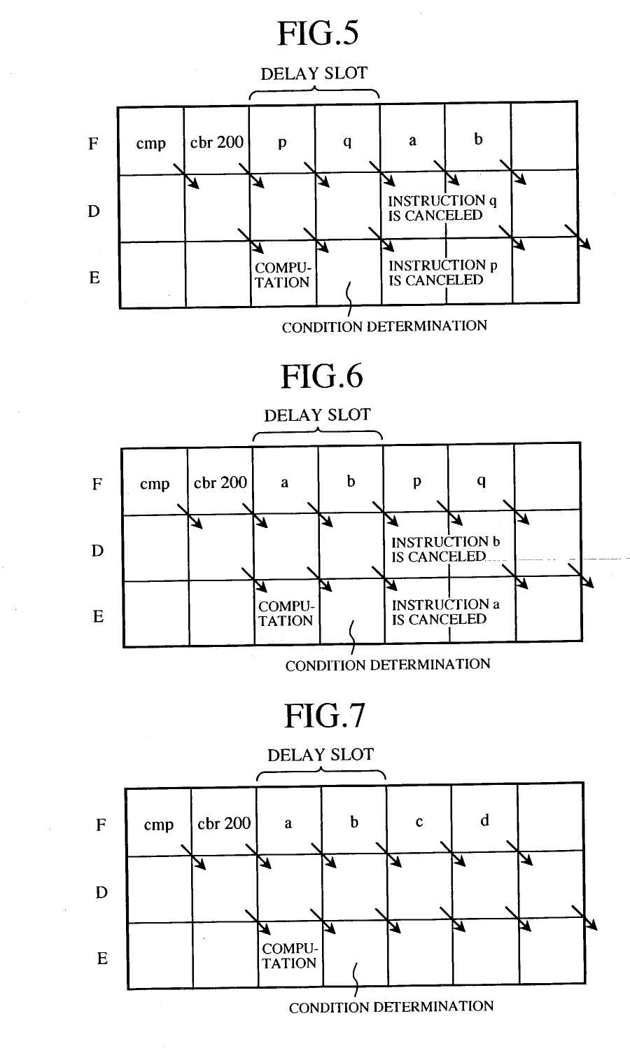

FIG. 6 is a diagram for explaining the pipeline processing in the case of the code sequence No. 3. When the code interface circuit 2 delivers the cmp to the operation code bus 8, the CPU 1 enters the cmp into the F stage. When the code interface circuit 2 supplies the cbr 200 to the operation code bus 8 in the next cycle, the cbr 200 is entered into the F stage. At this time, because the signal A has a value of “0”, the decode circuit 6 sets the value of the signal B to “0”. In response to the signal B having a value set to “0”, the code interface circuit 2 delivers the instruction a, which is next to the cbr 200, to the operation code bus 8 in the next cycle. The code interface circuit 2 further delivers the next instruction b to the operation code bus 8 in the next cycle. As a result, the two instructions a and b are introduced into the delay slot. Then, when the CPU 1 determines, in the E stage of the cbr 200, that the branch condition is satisfied, results 101 caused by the branch condition determination are delivered to the code interface circuit 2. In response to the branch condition determination results 101, the code interface circuit 2 delivers the two instructions p and q to the operation code bus 8 in the next or later cycle. The CPU 1 then cancels the execution of the instructions a and b that need not be executed because the branch condition is unsatisfied.

Thus, when the cbr 200 is executed with the value of the signal A being preset to “0” with the program, the instruction a, which is next to the cbr 200, and the next instruction b are sequentially entered into the delay slot. After that, when it is determined, in the stage E of the cbr 200, that the condition is satisfied, the instructions a and b entered into the delay slot are canceled. The instructions p and q, which are the destination of the conditional branch with the condition satisfied, are delivered to the CPU 1 after whether the condition for the cbr 200 is satisfied or unsatisfied is determined, and are sequentially executed by the CPU 1. When the branch condition is thus satisfied with the signal A having a value of “0”, the delay slot are not filled with any effective instructions and this results in no improvement in the CPU performance.

FIG. 7 is a diagram for explaining the pipeline processing in the case of the code sequence No. 4. The value of the signal B becomes “0” even in the case of the code sequence No. 4 because the value of the signal A is set to “0”. The code interface circuit 2 outputs the instruction a in a cycle next to the cycle in which the cbr 200 is delivered to the operation code bus 8, and then outputs the instruction bin the next cycle. As a result, the two instructions a and b are introduced into the delay slot. Then, when the CPU 1 determines, in the E stage of the cbr 200, that the branch condition is unsatisfied, results 101 caused by the branch condition determination are delivered to the code interface circuit 2. In response to the branch condition determination results 101, the code interface circuit 2 delivers the two instructions c and d to the operation code bus 8 in the next or later cycle.

Thus, when the cbr 200 is executed with the value of the signal A being preset to “0” with the program, the instruction a, which is the destination of the conditional branch with the condition satisfied, and the next instruction b are sequentially entered into the delay slot. After that, when it is determined, in the stage E of the cbr 200, that the condition is unsatisfied, the instructions c and d are sequentially executed by the CPU 1. When the branch condition is thus unsatisfied with the signal A having a value of “0”, the delay slot are filled with the effective instructions a and b and this results in an improvement in the CPU performance.

Such implementation of the code sequences No. 1 to No. 4 makes it possible to improve the performance of the CPU at the execution time of each conditional branch. In other words, by creating the program such that the value of the signal A, which is stored in the register 5, is set to “1” for program segments with a high frequency with which the branch condition for a conditional branch is satisfied, whereas the value of the signal A is set to “0” for program segments with a low frequency with which the branch condition for a conditional branch is satisfied, the execution time of the entire program can be shortened.

When the microprocessor according to embodiment 1 is incorporated into equipment in which quick response is essential, there may be cases where a conditional branch, which jumps to a sub routine to be executed if the branch condition is satisfied, needs high CPU performance only if the branch condition is satisfied, but need not high CPU performance if the branch condition is unsatisfied. The value of the signal A, which is stored in the register 5, can be set to “1” for such a conditional branch before it is executed.

Next, a description will be made as to the introduction of the instructions p and q immediately after the cbr 200 has been entered into the CPU 1 with reference to FIGS. 4 and 5. In a normal circuit, after the cbr 200 is decoded in the stage D of the CPU 1, the CPU 1 calculates the address of the instruction p which is the destination of the conditional branch by using information on the decoding and then delivers the calculated address of the instruction p which is the destination of the conditional branch to the code interface circuit 2. At that time, the code interface circuit 2 starts prefetching the instruction p in advance for the first time. In other words, in a normal circuit, immediately after the cbr 200 is entered into the CPU 1, the instruction p which is the destination of the conditional branch cannot be entered into the CPU 1 from the code interface circuit 2 from the viewpoint of time.

Therefore, the code interface circuits 2 of embodiment 1 has the following structure. The code interface circuit 2 has two instruction prefetching buffers QUE1 and QUE2 as shown in FIG. 1. The QUE1 is the buffer currently being used, that is, the buffer into which the instructions cmp, cbr 200, a, and b are prefetched. The code interface circuit 2 decodes the instruction cbr 200 held by the QUE1 before delivering it to the CPU 1, calculates an address of the branch destination of the cbr 200 by using information on the decoding and the value of a program counter acquired from the CPU 1, and fetches the instructions p, q, and r and then stores them in the other instruction prefetching buffer QUE2.

When a conditional branch is thus included in the instruction prefetching buffer QUE1, by prefetching the instruction which is the branch destination of the conditional branch and storing it in the other instruction prefetching buffer QUE2, it is possible to enter the instruction p which is the branch destination of the conditional branch into the CPU 1 immediately after the cbr 200 has been entered into the CPU 1, as shown in FIGS. 4 and 5.

The code interface circuit 2 can have a structure similar to that of a prior art code interface circuit. In this case, because the code interface circuit 2 cannot prefetch the instruction p unless it receives the address of the branch destination of the cbr 200 from the CPU 1, as mentioned above, the delay slot cannot be filled with the instructions p and q when the signal A has a value of “1”. In contrast, when the signal A has a value of “0”, the delay slot can be filled with the instructions a and b. In other words, the delay slot can be effectively used only in the case of the code sequence No. 4 of FIG. 3, and the CPU performance can be improved even in this case because the prefetching of instructions with the code interface circuit 2 is carried out with efficiency according to the value of the signal A.

As mentioned above, in accordance with this embodiment 1, because the microprocessor can determine instructions to be entered into the delay slot according to a signal A output from the register 5 rewritable with software, by setting the value of the signal A according to the usage or the like of instructions included in the program, the microprocessor effectively uses the delay slot without using any branch prediction circuit, thereby improving the processing performance.

Embodiment 2.

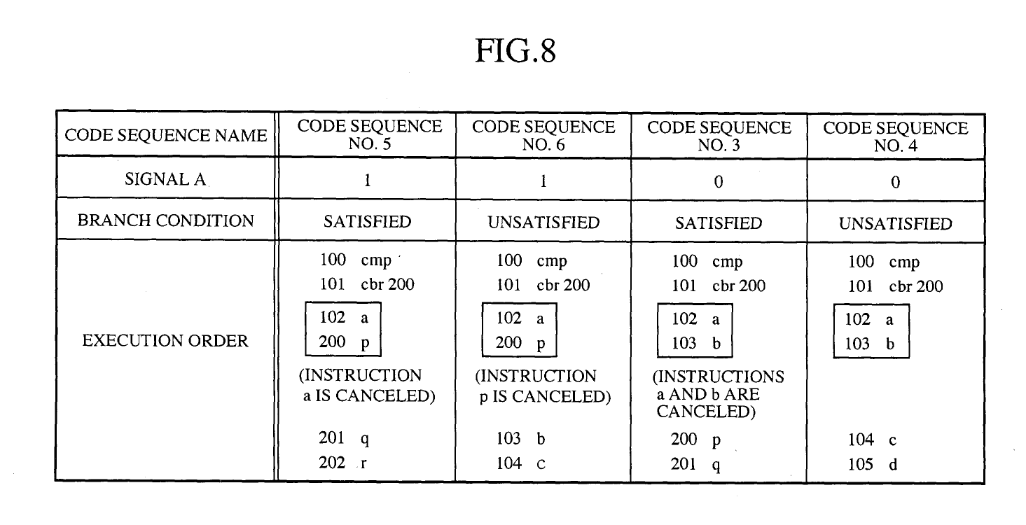

FIG. 8 is a table showing classified examples of the actual order of instructions to be executed when a microprocessor according to embodiment 2 of the present invention executes the program shown in FIG. 2. In the figure, instructions enclosed by a square in each code sequence are ones to be entered in a delay slot. Four code sequences No. 5, No. 6, No. 3, and No. 4 can be provided according to the value of a signal A and whether the branch condition for a cbr 200 is satisfied or unsatisfied. The operation (in the case of either of the code sequences No. 3 and No. 4) at the time when the signal A has a value of “0” is the same as that of the microprocessor of embodiment 1.

In accordance with embodiment 2, when the signal A has a value of “1”, the instruction a which is to be executed next when the condition is unsatisfied and the instruction p which is the branch destination, instead of the instruction p and the next instruction q, are entered into the delay slot. In the case of the code sequence No. 5, only the instruction a, which has been entered into the delay slot, is canceled when the CPU 1 determines that the branch condition for the cbr 200 is satisfied, and the instruction q is supplied to the CPU 1 by way of an operation code bus 8.

In the case of the code sequence No. 6, only the instruction p, which has been entered into the delay slot, is canceled when determined that the branch condition for the cbr 200 is unsatisfied, and a instruction b is then supplied to the CPU1 by way of the operation code bus 8.

Thus, one effective instruction is placed in the delay slot in the case of either of the code sequences, No. 5 and No. 6. In other words, in accordance with embodiment 2, when the program to be executed by the microprocessor has indefinite frequency with which the branch condition for each conditional branch is satisfied or unsatisfied, it is possible to shorten the execution time of the entire program by creating the program such that the value of the signal A is set to “1”.

Embodiment 3.

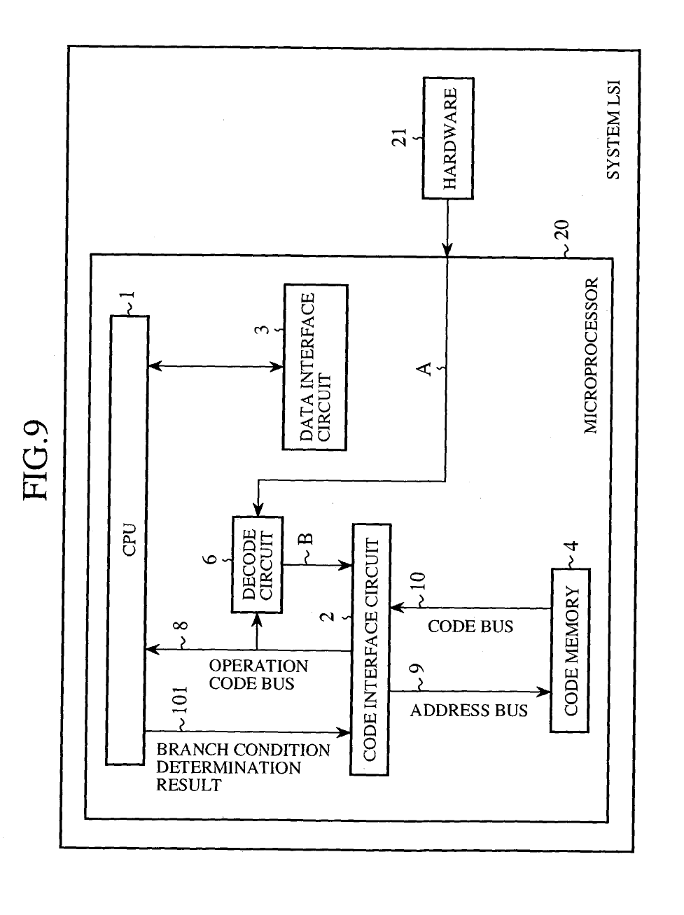

FIG. 9 is a block diagram showing the structure of a system LSI equipped with a microprocessor according to embodiment 3 of the present invention. The same reference numerals as shown in FIG. 1 denote the same components as those of the microprocessor of embodiment 1. In the figure, reference numeral 20 denotes the microprocessor, and reference numeral 21 denotes hardware disposed outside the microprocessor 20.

In accordance with embodiment 3, the hardware 21 rather than a register rewritable with software outputs a signal A. The microprocessor included in the system LSI executes instructions in the same manner that that of embodiment 1 does.

When the system LSI according to embodiment 3 is incorporated into equipment, there may be cases where a signal for determining whether the branch condition for each conditional branch is satisfied or unsatisfied can exist on the hardware. The system LSI can be so constructed that this signal is input, as the signal A, to a decode circuit 6. In this case, the performance of a CPU 1 can be improved without using registers.

Embodiment 4.

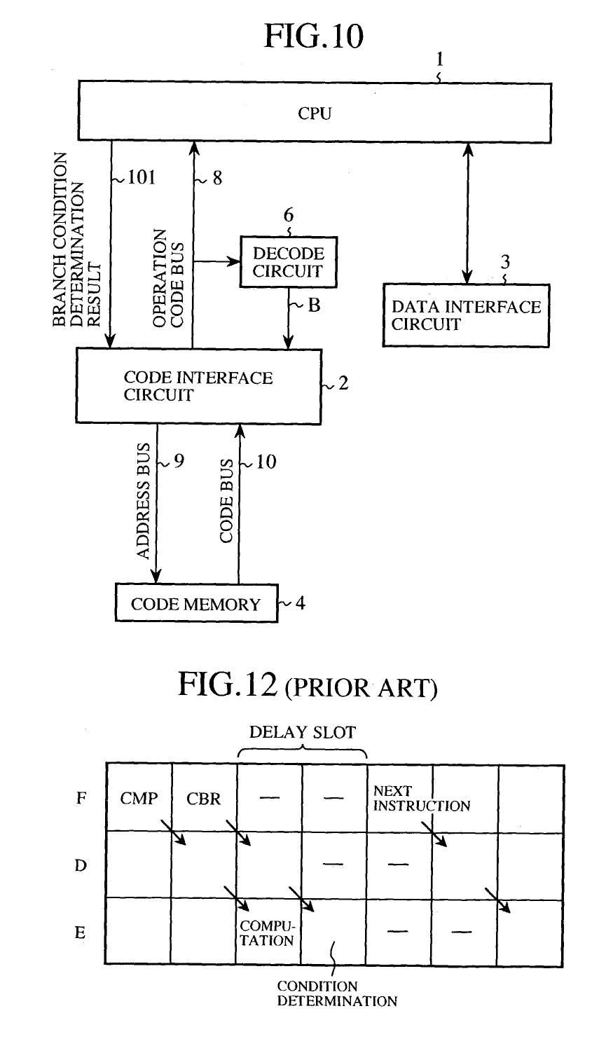

FIG. 10 is a block diagram showing the structure of a microprocessor according to embodiment 4 of the present invention. The same reference numerals as shown in FIG. 1 denote the same components as those of the microprocessor of embodiment 1. The microprocessor according to embodiment 4 has, as an instruction set, two instructions: a conditional branch satisfied prediction instruction and a conditional branch unsatisfied prediction instruction for each conditional branch. For example, it is assumed that the instruction cbr 200, which is included in the program shown in FIG. 2, has a conditional branch satisfied prediction instruction cbr_A200 and a conditional branch unsatisfied prediction instruction cbr_B200.

Next, a description will be made as to the operation of the microprocessor according to embodiment 4 of the present invention. Only when a conditional branch satisfied prediction instruction cbr_A200 is delivered to an operation code bus 8, a decode circuit 6 sets the value of a signal B to “1”. After that, the microprocessor executes successor instructions in the same way that that of embodiment 1 does.

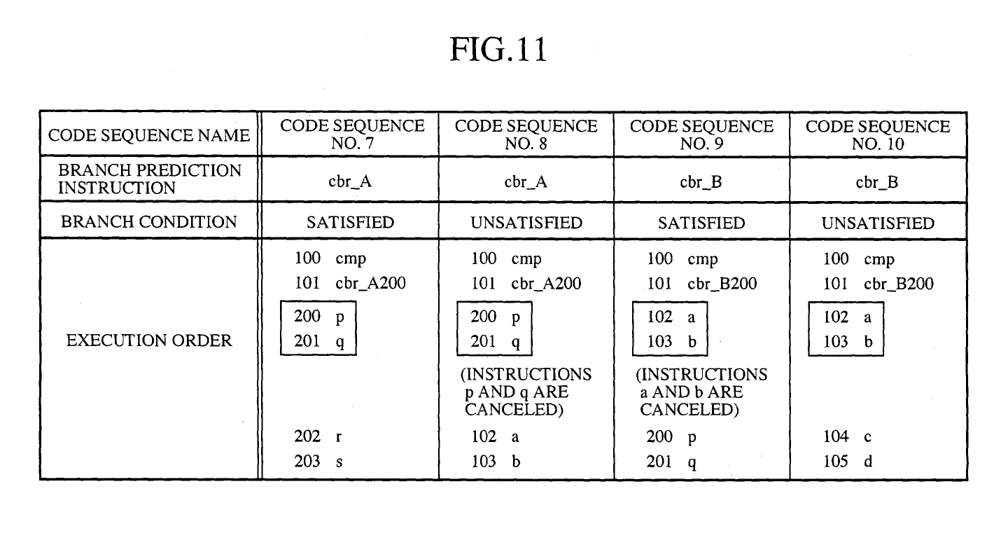

FIG. 11 is a table showing classified examples of the actual order of instructions to be executed when the microprocessor according to embodiment 4 of the present invention executes the program shown in FIG. 2. Four code sequences No. 7, No. 8, No. 9, and No. 10 can be provided according to the type of a conditional branch prediction instruction output onto the operation code bus 8 and whether the branch condition for the cbr 200 is satisfied or unsatisfied. When the cbr_A is executed, the instructions which are the branch destination with the branch condition satisfied are entered into the delay slot (in the case of either of the code sequences No. 7 and No. 8). On the other hand, when the cbr_B is executed, the instruction which is to be executed next when the branch condition unsatisfied and the next instruction are entered into the delay slot (in the case of either of the code sequences No. 9 and No. 10).

As a result, when the conditional branch satisfied prediction instruction cbr_A200 is executed and the branch condition is then satisfied, (in the case of the code sequence No. 7), and when the conditional branch unsatisfied prediction instruction cbr_B200 is executed and the branch condition is then unsatisfied, (in the case of the code sequence No. 10), the CPU performance can be improved.

As mentioned above, by creating the program such that the conditional branch satisfied prediction instruction cbr_A200 is used for a conditional branch having high frequency with which the branch condition is satisfied, and the conditional branch unsatisfied prediction instruction cbr_B200 is used for a conditional branch having low frequency with which the branch condition is satisfied, the execution time of the entire program can be shortened.

When the microprocessor according to embodiment 1 is incorporated into equipment in which quick response is essential, there may be cases where a conditional branch, which jumps to a sub routine to be executed if the branch condition is satisfied, needs high CPU performance only if the branch condition is satisfied, but need not high CPU performance if the branch condition is unsatisfied. By setting the conditional branch satisfied prediction instruction to such a conditional branch, the CPU performance can be improved.

As mentioned above, in accordance with this embodiment 4 of the present invention, because the microprocessor uses the conditional branch satisfied prediction instruction and the conditional branch unsatisfied prediction instruction for each conditional branch according to the usage or the like of instructions included in the program, there can be provided the same advantage as offered by above-mentioned embodiment 1 without using any register rewritable with software.

Furthermore, because it is not necessary to change the value of the signal A with the program, the amount of code memory can be reduced.

As mentioned above, in accordance with the present invention, there is provided an advantage of providing a microprocessor that effectively uses the delay slot without using any branch prediction circuit, thereby improving the processing performance.

In accordance with the present invention, there is provided an advantage of being able to select instructions to be entered in the delay slot at the design time of the software.

Many widely different embodiments of the present invention may be constructed without departing from the spirit and scope of the present invention. It should be understood that the present invention is not limited to the specific embodiments described in the specification, except as defined in the appended claims.

What is claimed is:

1. A microprocessor for, when a conditional branch is supplied from an executable instruction supply unit to an operation unit, introducing at least one of a successor instruction to be executed when a condition for the conditional branch is satisfied and another successor instruction to be executed when the condition is unsatisfied into a delay slot, said microprocessor comprising:
a register rewritable with a program, for outputting a first signal for determining which one of the successor instruction and the other successor instruction is to be introduced into the delay slot; and
a control unit for delivering a second signal that specifies which one of the successor instruction and the other successor instruction is to be supplied to said operation unit according to a value of the first signal to said executable instruction supply unit when the conditional branch is supplied from said executable instruction supply unit to said operation unit.

2. The microprocessor according to claim 1, wherein said control unit delivers the second signal that specifies which one of the successor instruction and the other successor instruction is to be supplied to said operation unit according to the value of the first signal which is output by hardware disposed outside said microprocessor instead of said register.

3. The microprocessor according to claim 1, wherein when the first signal has a value indicating the successor instruction to be executed when the condition is satisfied, said microprocessor introduces both the successor instruction and the other successor instruction into the delay slot.

4. The microprocessor according to claim 2, wherein when the first signal has a value indicating the successor instruction to be executed when the condition is satisfied, said microprocessor introduces both the successor instruction and the other successor instruction into the delay slot.

5. A microprocessor for, when a conditional branch is supplied from an executable instruction supply unit to an operation unit, introducing at least one of a successor instruction to be executed when a condition for the conditional branch is satisfied and another successor instruction to be executed when the condition is unsatisfied into a delay slot, said microprocessor comprising:
a conditional branch satisfied prediction instruction for introducing the successor instruction into the delay slot and a conditional branch unsatisfied prediction instruction for introducing the other successor instruction into the delay slot, as an instruction set for the conditional branch; and
a control unit for setting either one of the conditional branch satisfied prediction instruction and the conditional branch unsatisfied prediction instruction to the conditional branch when a program is created, and for delivering a second signal that specifies which one of the successor instruction and the other successor instruction is to be supplied to said operation unit to said executable instruction supply unit according to the set prediction instruction when the conditional branch is supplied from said executable instruction supply unit to said operation unit.
